(19) United States
(12) Patent Application Publication
(10) Pub. No.: US 2002/0128942 A1
(43) Pub. Date: Sep. 12, 2002

(54) System and method for purchasing goods and services and receiving a future return on investment

(76) Inventors: Mark Colosi, Honeoye Falls, NY (US); Franco Scalamandre, Marina Del Rey, CA (US)

Correspondence Address: JEFFER, MANGELS, BUTLER & MARMARO LLP, Tenth Floor, 2121 Avenue of the Stars, Los Angeles, CA, 90067, US

(21) Appl. No.: 09/803,057

(22) Filed: Mar. 9, 2001

(51) Int. Cl. G06F 17/60

(52) U.S. Cl. 705/36; 705/26; 705/14

(57) ABSTRACT

A method of obtaining a rebate. The method includes the steps of selling a product or service to a buyer for a price at a first point in time, providing the buyer with an expectancy of a rebate, wherein the expectancy equals a first amount at the first point in time, investing at least a portion of the first amount in a financial investment vehicle, and providing the rebate to the buyer after a predetermined amount of time. After the predetermined amount of time, the rebate equals a second amount. The second amount is equal to what the first amount has matured to in the financial investment vehicle during the predetermined amount of time. The second amount is approximately equal to the original price.

### FIELD OF THE INVENTION

The present invention relates to a system and method for purchasing goods and services and receiving a future return on investment.

### BACKGROUND OF THE INVENTION

Vendors are continuously seeking new ways of encouraging buyers to purchase their goods and services. At the same time, people are always looking for a way to better invest their money. In particular, people are interested in saving for the future and retirement.

A long felt need for ways to invest money continues to exist, despite the plurality of options available. It would be advantageous to provide a method and system wherein people can purchase goods and services while at the same time are able to invest a portion of the purchase price.

### SUMMARY OF THE PREFERRED EMBODIMENTS

In accordance with a first aspect of the present invention there is provided a method of receiving a payment. The method includes the steps of making a purchase for a first amount, obtaining a rebate that is a portion of the first amount and defining an investment by investing at least a portion of the rebate into a financial investment vehicle. The investment is projected to be valued at a second amount after a predetermined period of time. After the predetermined period of time, the second amount is forecasted to be valued substantially the same as the first amount based upon the historic financial performance of the investment, and the second amount is received by the purchaser as a payment. In a preferred embodiment, the financial investment vehicle provides an interest rate between 5% and 25% and the predetermined period of time is at least 20 years.

In accordance with another aspect of the present invention, there is provided a method of determining a sales rebate. The method includes the steps of selecting a purchase price, selecting an interest rate, selecting a period of time, and determining an amount that when compounded at the interest rate over the period of time will be substantially equal to the purchase price. The determined amount is the sales rebate.

In accordance with another aspect of the present invention, there is provided another method of receiving a payment. The method includes the steps of making a purchase, obtaining a rebate, defining an investment by investing at least a portion of the rebate into a financial investment vehicle, wherein the investment accumulates to a second amount that is substantially the same as the first amount, and receiving the second amount as a payment.

In accordance with yet another aspect of the present invention there is provided a method of obtaining a rebate. The method includes the steps of making a sale to a consumer for a price at a first point in time, providing the consumer with an expectancy of a rebate, wherein the expectancy equals a first amount at the first point in time, investing at least a portion of the first amount in a financial investment vehicle, and providing the rebate to the consumer after a predetermined amount of time. After the predetermined amount of time, the rebate equals a second amount. The second amount is equal to what the first amount has matured to in the financial investment vehicle during the predetermined amount of time. The second amount is projected to be equal to the price assuming an investment yield equivalent to the historic financial performance of the financial investment.

In accordance with yet another aspect of the present invention there is provided a financial investment system for providing a purchaser of a product or service for a price with an estimated return of that price after an amount of time. The system includes a system website through which products and services are offered for sale at a price. The products and services are offered by at least one vendor. The system also includes means for receiving funds from the at least one vendor. The funds represent a percentage of the purchase price of one of the products or services purchased by a purchaser. The system also includes means for investing at least a portion of the funds into a financial investment vehicle for the benefit of the purchaser, and means for providing the purchaser with consideration estimated to be substantially equivalent to one hundred percent of the price of the products and services after a fixed period of time.

In a preferred embodiment of the present invention the absolute return of the purchase price is not guaranteed to the buyer. In this embodiment, a rebate is set aside that will return the purchase price in full if the historic rate of return on the investment on the financial investment vehicle maintains itself for the future period. In another embodiment, the purchase price is returned in a variable period depending upon the yield of the investment.

Other objects, features and advantages of the present invention will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The invention may be more readily understood by referring to the accompanying drawings in which

FIG. 1 is a flow chart showing a method of providing a rebate in accordance with a preferred embodiment of the present invention.

FIG. 2 is a general block diagram/flowchart showing a rebate transaction system in accordance with a preferred embodiment of the present invention.

Like numerals refer to like parts throughout the several views of the drawings.

### DETAILED DESCRIPTION OF THE PREFERRED EMBODIMENTS

Described herein are preferred embodiments of a system and method for purchasing a good or service and thereafter receiving a return on investment after a predetermined period of time or when the invested rebate plus the accumulated financial return equals the original purchase price. It will be understood that the good or service to be purchased is not a limitation on the invention and that the examples used herein are merely exemplary for aiding in the understanding of the present invention. As used herein, “purchase” means any transaction where the beneficial use or enjoyment of a product or service is received by a buyer. As used herein, “product or service” or “good or service” includes without limitation, a lease, installment sale, land contract, easement or other conveyance of the right to beneficial use or enjoyment. As used herein “sale” means any transaction where the beneficial use or enjoyment of a product or service is conveyed to the buyer, including without limitation, buying a good or service, a lease, installment sale, land contract, easement or other conveyance of the right to beneficial use or enjoyment.

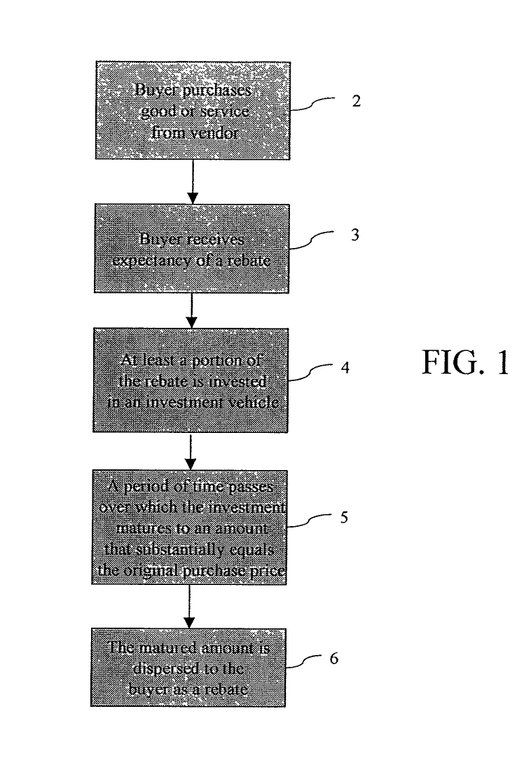

As shown in FIG. 1, generally, in a preferred embodiment, the present invention includes the following steps: A buyer purchases a good or service from vendor 2; the buyer receives an expectancy of a rebate 3; at least a portion of the rebate is invested in an investment vehicle 4; a period of time passes over which the investment matures to an amount that substantially equals the original purchase price 5; and the matured amount is dispersed to the buyer as a rebate 6. Expectancy of a rebate as used herein means that a buyer is notified or informed that they will at a future time receive a rebate. It will be understood that the steps of the method described in FIG. 1 do not have to be performed in the specified order. For example, the buyer may receive the expectancy of a rebate before the purchase. The buyer may receive an e-mail, slip of paper or other physical notification that an investment has been made on their behalf and that they will receive a rebate at some point in the future.

The method(s) described herein can be performed in any number of different mediums. For example, the buyer can purchase the goods on the internet or other computer network, over the telephone, in a store, via mail, etc. It will be understood that the medium in which the method is performed is not a limitation on the present invention. Any transactional system for purchasing goods or services is within the scope of the present invention.

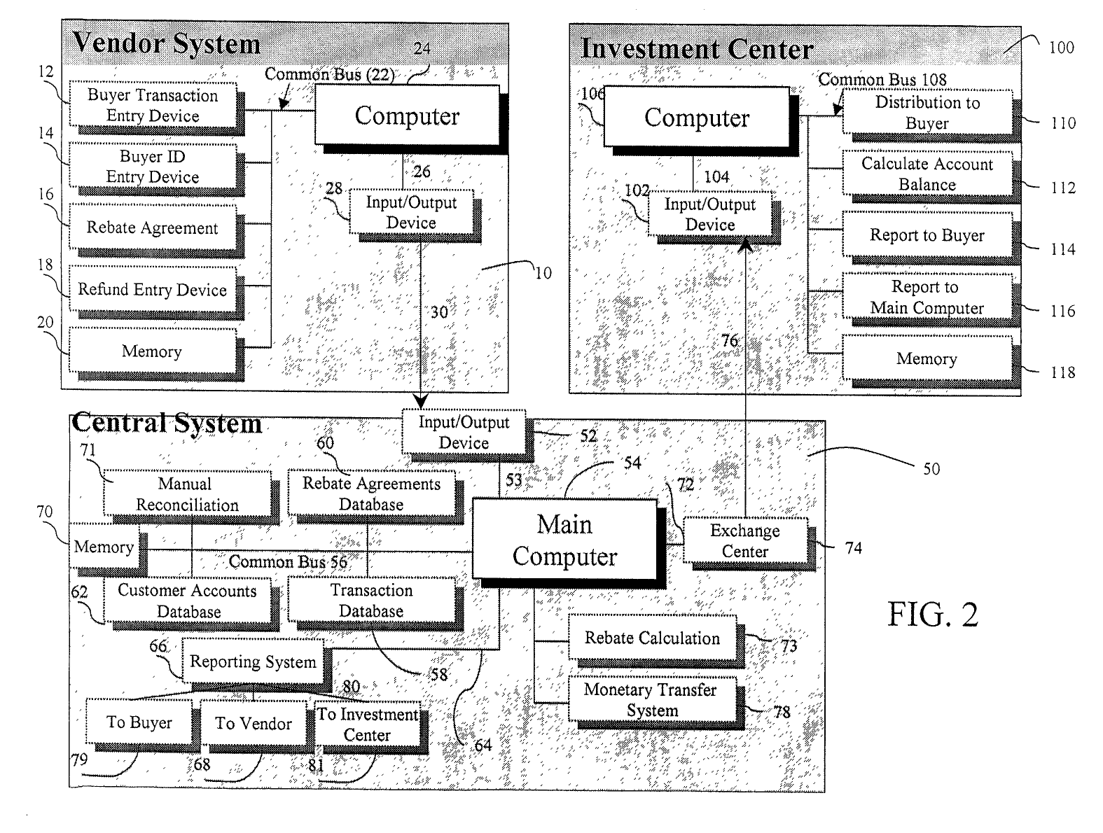

Referring to FIGS. 1-2, a preferred method and system for purchasing a good or service and receiving a rebate either after a predetermined period of time or upon the invested rebate plus the accumulated profit thereon equaling the original purchase price will be shown and described. In a preferred embodiment, the future rebate or return is substantially the same as the original purchase price. However, this is not a limitation on the present invention. A transaction occurs when a buyer, either a consumer or a business, purchases goods and/or services from a vendor. According to the block diagram shown in FIG. 2, the transaction is entered into the buyer transaction entry device 12 within the vendor system 10, either by the buyer themselves or automatically by the vendor system 10. The buyer transaction entry device 12 is preferably an electronic cash register or electronic shopping cart (such as is used on the Internet). However, any mode, electronic or otherwise, of recording information relating to the transaction, including written journal entry, credit or debit card swipe, bar code scan, sales receipt tender or the like can be used. The vendor system 10 is preferably an electronic cash register or electronic shopping cart networked to a central computer that compiles all transactional information. The vendor system 10 may be a computer system, manually kept database or set of books or any system in which information can be stored and the transactions described below can be performed. The information entered preferably includes, without limitation, a description of the goods and/or services that are the subject of the transaction and an amount representing the gross purchase price, preferably of each item purchased. At a time approximately concurrent with the entry of the transaction, the buyer or the vendor on the buyer's behalf enters buyer identifying information into a buyer ID entry device 14. This identifying information is preferably a membership number, but may be a name, social security number, biometric, or other unique identifying information. The means of entry may be by typing, manual writing, card swipe, biometric measurement, infrared scanning, or the like.

Additionally present in the vendor system 10 is a rebate agreement 16 that contains unique identifying information for the vendor and the terms of the agreement between the vendor and the central system 50 (described below). The terms of the agreement between the vendor and the central system 50 in a preferred embodiment include a fixed amount of the gross price paid by the buyer that is to be remitted to the central system 50. In this case, the vendor sends the payment to the central system 50, which then sends the payment to the investment center 100. In another preferred embodiment, the vendor sends the payment directly to the investment center 100 (described below). In another preferred embodiment, the vendor sends the amount to be invested to the investment center 100 and the balance to the central system 50. Preferably, the rebate agreement specifies the time period within which the vendor must made payment under one of the above scenarios. For example, fifteen days from the end of the month following the transaction date. It will be understood that the terms of the rebate agreement 16 are not a limitation on the present invention. As used herein, the term rebate is not intended to be limiting, but indicates that the buyer expects to receive a return (whether it be monetary or a good or service, etc.) at some future point in time.

The vendor system 10 can also include a refund entry device 18 that is a means for crediting amounts relating to previous transactions. The vendor preferably makes such entries. Without limitation, the foregoing information relating to a transaction, the description of the goods and/or services, the amount of each item, the buyer ID, the rebate agreement information, and any refund information, are stored in a memory device 20 within the vendor system 10. All these elements are connected by a common bus 22 to a central processing unit or computer 24.

The vendor system computer 24 correlates all data regarding a specific transaction and also may aggregate data with respect to a specific buyer. At predetermined intervals, preferably daily, the computer transmits through a bus 26 information from that period's transactions to an input/output device 28. The input/output device 28 can be interrupt driven (can run on a push communications architecture) or polling driven (can run on a pull communications architecture). In other words, the input/output device 28 can send interrupts to or push the information to the computer 24 or the computer 24 can poll or pull the information from the input/output device 28 at predetermined time intervals. It will be understood that these communication structure examples apply to all input/output devices and computers described herein. The vendor input/output device 28 transmits the information electronically via a transmission mechanism 30, for example, by either electronic data interchange, wide area network, internet, or the like, to the central system input/output device 52.

In the central system 50, the input/output device 52 transmits, via a transmission mechanism 53, the transaction information as received from the input/output device 28 of the vendor system 10 to the main computer 54. In a preferred embodiment, the central system 50 is a computer or network of computers that records and processes the mentioned data and transactions and generates written and electronic reports to the various entities discussed herein. The main computer 54 aggregates data from all vendors regarding all buyers, and all transactions, and correlates them to the reporting period (for example, daily electronic reports and quarterly paper reports). The main computer 54 preferably has the ability to sort and select this information in any format requested by the central system operator 50, for example, by vendor, by buyer, by type of transaction, and/or by time period.

The main computer 54 utilizes a common bus 56 of the central system 50 to store the transaction information received from the vendors in a transaction database 58. The main computer 54 also utilizes the common bus 56 to compare the rebate agreement information submitted from the vendor system 10 with the information stored in its rebate agreements database 60, and match the buyer identification information with the information stored in the customer accounts database 62.

In the event the rebate agreement information transferred from the vendor does not match the information stored in the rebate agreements database 60, the main computer 54 generates an error notification which is sent to both the central system operator as well as the vendor through the reporting system bus 64 and system 66, and generates a report to the vendor. In the event the buyer identification information transferred from the vendor does not match the information stored in the customer accounts database 62, the main computer 54 generates an error notification to both the central system operator as well as the vendor through the reporting system bus 64 and reporting system 66, and generates a report to the vendor 68.

The customer accounts database 62 also provides the means for partial or full assignment of the benefits of the customer's account at the investment center 100, which is preferably written or electronic notification by the buyer to the central system 50 of the assignment of the buyer's benefits, partial or full, to one or more third parties (for example, an assignment to a family member or charity). The system also includes memory 70 to store all operations of the main computer 54 with respect to all elements of the central system 50.

Additionally, as requested by a vendor, buyer, or as deemed appropriate by the central system operator, transactional and other information received by the main computer 54 may be modified by a manual reconciliation 71, which is generally controlled by the central system operator, and which modifications to the electronic records are transmitted through the common bus 56 and stored in the memory 70.

Next, utilizing the transaction information submitted by the vendor system 10, the main computer 54 performs a rebate calculation 73 due to the buyer for that particular transaction. The main computer 54 then transmits the information as to the amount of the rebate calculation 73 through a common bus 72 to the exchange center 74. The exchange center 74 transmits the information regarding the rebate calculation 73 through a transmission system 76 to the input/output device 102 of the investment center 100 via electronic data interchange, wide area network, internet or the like. The transmission system 76 may be either electronic data interchange, wide area network, internet, or the like. Preferably, the main computer 54 also directs the physical transfer of funds from the rebate amounts received from the vendors to the investment center through the monetary transfer system 78.

As required by securities or other applicable regulations, the rebate funds from the vendors may be transferred directly to the investment center 100 from the vendor system 10 without receipt by the central system 50, in which case the main computer 54 would provide the same information transfer functions except that the monetary transfer system 78 would be located within the investment center 100. Additionally, the main computer 54 as part of the foregoing functions updates the system memory 70 and customer account database 62 as to the rebate calculation 73 and the transfer of funds to the investment center 100 through the monetary transfer system 78.

Upon completion of the foregoing transaction processing, the main computer 54 transfers the updated customer account 62, transaction database 58, manual reconciliation 71, rebate calculation 73, and the transfer of funds from the monetary transfer system 78, through the common bus 64, to a reporting system 66. The reporting system 66 provides reports of the foregoing information to the buyer 79, vendor 68, and investment center 81 through an electronic (either electronic data interchange, wide area network, internet or the like), and/or paper transmission system 80. These reports may be in different forms, such as electronic or paper, and generated for different periods of time, most preferably daily for electronic reports to the buyer 79, monthly for electronic and paper reports to the vendor 68, and daily for electronic reports to the investment center 81. However, the period of time for which reports are generated is not a limitation on the present invention.

The input/output device 102 at the investment center 100 receives the information regarding the customer account 62, transaction amount, and preferably a transaction descriptor from the transaction database 18, which has been correlated by the main computer 54 and transferred through the exchange center 74 through an electronic communications system 76. The input/output device 102 communicates through an electronic bus 104 to the computer 106 at the investment center 100 that appropriately handles and routes the data received. Through a common bus 108, the computer 106 at the investment center 100 calculates pursuant to predetermined criteria when distributions are permissible to the buyer 110. Distributions are permissible to the buyer either because of the lapse of a predetermined period of time (for example, twenty five years) or on the basis of other pre-determined criteria such as the buyer's age (for example, the distribution date may be when the buyer reaches the age of 65) or because the rebate plus accumulated profits equals the original purchase amount. When the investment center computer 106 calculates that a distribution is permissible to the buyer, and/or the date of permissible distribution is reached, if such is a future date, the investment center computer 106 transmits the information to the buyer either immediately or on a periodic basis. The information can be transmitted to the buyer either in electronic or paper form (or both). In another embodiment, the permissible distribution date(s) can be transmitted to the buyer upon the buyer's request. The computer 106 also calculates the buyer's account balance 112 on a periodic basis. The account balance includes the sum of all funds transmitted to the investment center 100 on the buyer's behalf plus any accumulated interest or profits on the investments made by the investment center 100 with the funds that have been identified to the buyer. The investments made are not a limitation on the present invention. For example, the investments may be made in mutual funds, stocks, bonds, CD's, or any other investment vehicle. In a preferred embodiment, the investment vehicle is a low cost stock index mutual fund whose historic yield is 11% or greater. If such investment were held for the accumulation period, the ordinary income and capital gains during the accumulation period would be minimized and the after tax investment yield during the accumulation period would be maximized. One of the advantages of the system is in selling undifferentiated products (e.g. index mutual funds or insurance products) because it helps differentiate the products.

In one embodiment, the foregoing transactions may take place with a pooling of funds where each buyer owns an interest in a pool of funds that represents the total amount of funds transmitted to the investment center 100 on behalf of all buyers. In another embodiment, the legal title to the funds transmitted to the investment center 100 is not vested in the individual buyers but in some other entity as determined by the investment center 100 and the central system 50. In this situation, the individual buyers only obtain a legal right to the funds when the predetermined distribution date is reached.

The computer 106 may also calculate, on a pre- and/or post tax basis, the future time period t required for the amount transmitted to the investment center 100 to accumulate until it equals the original transaction purchase price p, assuming the calculated account balance b and a fixed interest rate i, both determined at the time of the projection or calculation.

In another embodiment, the computer may calculate the projected future value of the buyer's account y, on a pre- and/or post tax basis, at a specific time in the future y, assuming the calculated account balance b and a projected fixed yield i, both determined at the time of the projection or calculation. In mathematical terms:

y=b(1+i)^{t}

For example, a buyer purchases a good for $10 and $1 of that $10 is transferred to the investment center 100 for investment in a low cost stock index mutual fund with a projected yield net of taxes of 9.64% per year, it would take approximately 25 years for the amount in the buyer's account y to equal $10, the original purchase price of the good.

10=1(1+0.0964)²⁵

As can be seen from the above example, if the investment is made appropriately, after a predetermined amount of time, the buyer can recover his entire purchase price on a pre-tax basis. The good or product service is essentially free. In a preferred embodiment, the financial investment vehicle provides a historic, and therefore projected, interest rate between 5% and 25% and the predetermined period of time is at least 20 years. However, these figures are not a limitation on the present invention.

Referring once again to FIG. 2, the investment center computer 106 calculates both of the foregoing values (X and Y) until a projected target is reached and the projected value at a specific future time and transmits such information through the common bus 108 to the report to buyer 114, where such information is transmitted to the buyer on a periodic basis in electronic and/or paper formats.

The computer 106, through the common bus 108, also transmits the calculated account balance 112 to the buyer on a periodic basis. This can be done through the report to buyer 114, which report is preferably on a daily basis in electronic form. The report can be forwarded to the buyer, without limitation, via e-mail, by paper or by posting the information on a website accessible with password. The report and/or a summary of the past years activities can be transmitted to the buyer in electronic or written form.

The computer 106, through the common bus 108, also transmits the calculated account balance 112 and distribution to buyer 110 information on a periodic basis. Preferably, the transmission is in electronic form to the main computer 116, which through the common bus 56 at the central system 50 updates the customer accounts database 62 and the central system memory 70. All computational and transactional information relating to the information received by the computer 106 and processing information conducted by the computer 106 is transmitted through the common bus 108 to the investment center memory 118 for storage and recollection as required.

It will be understood that the software present on the vendor system computer 24, central system main computer 54 and investment center 106 is known in the art. It will be appreciated by those skilled in the art that spreadsheet programs, such as MICROSOFT EXCEL™, or database programs, such as MICROSOFT ACCESS™, can organize and correlate the data as necessary. Any standard database that has calculated fields that can automatically determine the rebate amounts can be used to practice the present invention.

An example of the present invention is set forth below. It will be understood that the example is merely exemplary and not intended to limit the scope of the present invention. A buyer goes to the vendor and purchases a sofa for $1,000. The buyer preferably has previously entered into a membership agreement with a company (central system 50) utilizing the system set forth above (referred to in this example as the “Company”) and has received a membership number. In initiating the membership relationship, the Company preferably captures notification information about the buyer, information required by tax authorities to report any investment gains attributable to the buyer as part of the operation of the invention, and provides all notices required by securities and other applicable regulations. The vendor preferably also has previously entered into an agreement with the Company. This agreement defines the percentage of the purchase price to be paid by the vendor to the Company, when such payments are due, and provisions for the exchange of information between the vendor (via the vendor system 10) and the Company.

At the time of the purchase, the buyer provides the vendor with his name, membership number, and potentially other identifying information. Upon completion of the purchase (delivery of goods or services), the vendor notifies the Company through an electronic communication of the buyer's name and membership number, a description of the goods purchased, and the amount of the purchase. The Company then posts this information to an electronic bulletin board preferably on a web site, where the buyer, with a pass code, can view the information about the item purchased and the purchase price, which is the projected value of his account in a certain period of time, for example, twenty five years.

Within fifteen days of the end of the calendar month following the date of purchase, the vendor transmits to the Company a rebate that is a proportion of the purchase price previously agreed to between the Company and the vendor, for example, 15% of the purchase price or $150. This transfer follows a reconciliation between the vendor and the Company as to the exact amount of the rebate due to the Company. The Company then transfers a fixed percentage of the purchase price, for example, 10% or $100, to the Investment Center 100 that invests that amount on behalf of the buyer. The Company determines the percentage of the purchase price transferred to the Investment Center by determining the future period in which the purchase price will be repaid, for example 25 years, the assumed investment yield which is preferably equivalent to the historic yield of the selected investment, for example, 9.65%, and then calculating the present value, in this example the present value of $1,000 in 25 years discounted at 9.65% is $100. The assumed investment yield is preferably net of tax consequences as any interim payment of taxes prior to the dispersal date in 25 years will reduce the effective investment yield, resulting in either the full purchase price not being returned in 25 years or taking longer than 25 years to achieve the full purchase price. For this reason, a preferred embodiment of the invention includes the use of indexed stock investments held for the duration of the investment period to result in a minimum of ordinary income or capital gains tax during the accumulation period. As required by securities or other laws, the rebate may be transferred from the vendor to a regulated financial intermediary who then transfers the $100 to the Investment Center and the balance of the rebate, $50, to the Company.

The $100 transferred to the Investment Center preferably accumulates for the sooner of 25 years or until such time as the transfer plus accumulated appreciation equals $1,000, the original purchase price.

In the event the 25 year period is reached and the investment has under performed its historic yield so that the account balance is less than the original purchase price, in the preferred embodiment the buyer would have the option of then receiving a rebate of less than the purchase price or letting the investment continue to accumulate. During the accumulation period, the Investment Center preferably provides reports to the buyer as to the projected future value of the account, on both a pre- and post tax basis, assuming the historical yield of the selected investment. These reports would preferably be monthly as electronically posted to a web site and annually on paper as such is required by securities or other regulations.

Upon either the expiration of the 25-year period or the accumulation of the rebate to reach to original purchase price, the Investment Center notifies the buyer of his right to receive the rebate and distributes the rebate to the buyer at his request. In a variation, the buyer could assign part or all of his interest in the rebate to third party entities as he sees fit, for example, to charities, family members, or other third parties designated by the buyer.

While there are a variety of investments that can be used in connection with this invention, at the present time, the most preferable investment is a stock index mutual fund.

The embodiments of the present invention recited herein are intended to be merely exemplary and those skilled in the art will be able to make numerous modifications to them without departing from the spirit of the present invention. For example, the concept can be equally applied to long term leases, such as a long term mortgage, as it is to sales. All such modifications are intended to be within the scope of the present invention as defined by the claims appended hereto.

What is claimed is:

1. A method of receiving a payment, said method comprising the steps of:
a) making a purchase for a first amount,
b) obtaining a rebate, wherein said rebate is a portion of said first amount,
c) defining an investment by investing at least a portion of said rebate into a financial investment vehicle,
wherein said investment is projected to be valued at a second amount after a predetermined period of time, wherein said second amount is substantially the same as said first amount, and
d) receiving said second amount as a payment.

2. The method of claim 1 wherein said financial investment vehicle is projected to provide an interest rate between 5% and 25%.

3. The method of claim 1 wherein said predetermined period of time is at least 20 years.

4. The method of claim 1 wherein said purchase is made via the Internet.

5. The method of claim 1 wherein said purchase includes purchasing a product or service selected from a group of products or services provided by at least one vendor.

6. The method of claim 1 further comprising the step of returning said second amount to the purchaser or the assignee of the purchaser.

7. A method of determining a sales rebate, said method comprising the steps of:
a) selecting a purchase price,
b) selecting an interest rate,
c) selecting a period of time, and
d) determining an amount that when compounded at said interest rate over said period of time will be substantially equal to said purchase price, wherein said determined amount is said sales rebate.

8. The method of claim 7 wherein said interest rate is between 5% and 25%.

9. The method of claim 7 wherein said period of time is at least 20 years.

10. The method of claim 7 wherein the step of selecting a purchase price is performed by a buyer making a purchase having said purchase price.

11. A method of receiving a payment, said method comprising the steps of:
a) making a purchase for a price,
b) obtaining a rebate, and
c) defining an investment by investing at least a portion of said rebate into a financial investment vehicle, wherein said investment accumulates to a second amount, wherein said second amount is substantially the same as said first amount, and
d) receiving said second amount as a payment.

12. A method of obtaining a rebate, said method comprising the steps of:
a) making a sale to a buyer for a price at a first point in time,
b) providing said buyer with an expectancy of a rebate, wherein said expectancy equals a first amount at said first point in time,
c) investing at least a portion of said first amount in a financial investment vehicle, and
d) providing said rebate to said buyer after a predetermined amount of time, wherein said rebate equals a second amount, said second amount being equal to what said first amount has matured to in said financial investment vehicle during said predetermined amount of time,
wherein said second amount is projected to be approximately equal to said price.

13. A financial investment system for providing a purchaser of a product or service for a price with a return of that price after an amount of time, said system comprising:
a) a system website through which products and services are offered for sale at a price, wherein said products and services are offered by at least one vendor,
b) means for receiving funds from said at least one vendor, wherein said funds represent a percentage of the purchase price of one of said products or services purchased by a purchaser,
c) means for investing at least a portion of said funds into a financial investment vehicle for the benefit of the purchaser, and
d) means for providing the purchaser with consideration substantially equivalent to one hundred percent of the purchase price after a fixed period of time.

14. The financial investment system of claim 13 wherein said at least one vendor's products or services are offered for sale on said system website.

15. The financial investment system of claim 13 wherein said products or services are offered for sale on the at least one vendor's website, and wherein said system website includes links to said at least one vendor's website.

16. The financial investment system of claim 13 wherein said funds are equivalent to at least five percent of the price.

17. The financial investment system of claim 13 wherein said funds are equivalent to at least ten percent of the price.

18. The financial investment system of claim 13 wherein said consideration is provided in the form of cash.

19. The financial investment system of claim 13 wherein said consideration is provided in the form of products or services.

20. The financial investment system of claim 13 wherein said fixed period of time is at least 20 years.

21. The financial investment system of claim 1 wherein said investment is a stock index mutual fund.

22. The financial investment system of claim 11 wherein said investment is a stock index mutual fund.

23. The financial investment system of claim 13 wherein said investment is a stock index mutual fund.
